(19) United States
(12) Patent Application Publication
(10) Pub. No.: US 2025/0031710 A1
(43) Pub. Date: Jan. 30, 2025

(54) METHOD FOR PREPARING LACTOSE-FREE DAIRY PRODUCT CONTAINING GALACTOOLIGOSACCHARIDES, AND DAIRY PRODUCT THEREOF

(71) Applicant: THE COCA-COLA COMPANY, Atlanta, GA (US)

(72) Inventors: Boya LIU, Atlanta, GA (US); Xinwei FENG, Atlanta, GA (US); Jia LI, Atlanta, GA (US); Tushar JOSHI, Atlanta, GA (US); Fujun GAO, Atlanta, GA (US); Jia Wei HUANG, Atlanta, GA (US)

(21) Appl. No.: 18/715,653

(22) PCT Filed: Dec. 1, 2022
(86) PCT No.: PCT/US2022/051495

§ 371 Date: Jun. 3, 2024

(30) Foreign Application Priority Data
Dec. 1, 2021 (CN) 202111453072.8

(51) Int. Cl. A23C 9/12

(52) U.S. Cl. CPC A23C 9/1206

(57) ABSTRACT

Disclosed is a method for preparing a lactose-free dairy product containing galactooligosaccharides, comprising a step of using ordinary lactase and β-galactosidase with transgalactosylation activity, wherein the ordinary lactase decomposes lactose in a dairy product starting material to galactose and glucose; wherein the β-galactosidase with transgalactosylation activity decomposes lactose in the dairy product starting material to galactose and glucose, and transfers galactose obtained through decomposition onto a hydroxyl group of lactose in the dairy product starting material to achieve conversion to galactooligosaccharides, and optionally, conversion to higher-order galactooligosaccharides; and wherein the galactose obtained through decomposition comprises: 1) galactose obtained by decomposition of lactose by the ordinary lactase; and/or 2) galactose obtained by decomposition of lactose by the β-galactosidase with transgalactosylation activity. The disclosed method can produce galactooligosaccharides to a high level in situ, achieves a lactose-free standard through a simple process at a low cost, and provides a sugar reduction effect.

### CROSS REFERENCE TO RELATED APPLICATIONS

The application claims the priority from Chinese Patent Application No. 202111453072.8, filed with the China National Intellectual Property Administration on Dec. 1, 2021, the content of which is incorporated by reference in its whole entirety.

### TECHNICAL FIELD

The present invention relates to a method for preparing a dairy product, and a dairy product obtained by the method. In particular, the present invention relates to a method for preparing a lactose-free dairy product containing galactooligosaccharides, and a dairy product obtained by the method.

### BACKGROUND ART

Galactooligosaccharides (galactose oligosaccharide, GOS) are a type of functional oligosaccharide. Galactooligosaccharides are an effective growth factor and an excellent source of nutrition for beneficial bacteria such as Bifidobacterium and Lactobacillus acidophilus in the human intestine, so can improve digestion and absorption in the human intestine. Furthermore, lactose contained in cow's milk and dairy products for example, will cause adverse reactions such as stomach pain, flatulence and diarrhea in people with lactose intolerance. Thus, it is absolutely necessary to develop dairy products which contain galactooligosaccharides but are lactose-free.

In the prior art, the effect of increasing the content of galactooligosaccharides in dairy products while reducing lactose is generally achieved in the following two ways:

1) β-galactosidase with a high level of transgalactosylation activity is used to convert lactose in a dairy product starting material to galactooligosaccharides, for example:

CN101396048A has disclosed a method for producing milk rich in galactooligosaccharides, comprising heating cow's milk, isolating the fat to obtain skimmed milk, pasteurizing and then cooling, followed by hydrolysis with immobilized β-galactosidase, UHT sterilization, and then cooling and packaging. Thus, the method hydrolyses cow's milk with β-galactosidase to prepare milk rich in galactooligosaccharides. However, the lactose in the starting material of the dairy product prepared by such a method is not completely decomposed (see the lactose contents recorded in Examples 1-5 of said patent).

CN106455600A has disclosed a method for using β-galactosidase with a high level of transgalactosylation activity at a low temperature to produce a dairy product containing galactooligosaccharides, wherein heat treatment is used to bring about enzyme inactivation. Similarly, the lactose in the starting material of the dairy product prepared by such a method is also not completely decomposed (see the lactose content recorded in Example 3 of said patent).

2) Lactase is used to completely decompose lactose in a dairy product starting material, and galactooligosaccharides are added, for example:

CN104286174A has disclosed a method for preparing lactose-free fermented milk, wherein yeast lactase and fungal lactase are used successively in two steps, decomposing lactose in starting material milk to glucose and galactose, to obtain a lactose-free fermented milk, and wherein galactooligosaccharides are added as a sweetener to the starting material (see paragraph [0014] and Examples 2 and 4 of the specification). However, such a method requires the addition of galactooligosaccharides, which increases the production cost and introduces the risk of external contamination during production.

In addition, CN100473283C has further disclosed a method for producing a dairy product composition, wherein the use of multiple separation steps combining ultrafiltration, nanofiltration and reverse osmosis to obtain a lactose-free dairy product starting material is recorded. Although the combination of ultrafiltration, nanofiltration and reverse osmosis can achieve the effect of removing most of the lactose, the process is complex with high energy consumption and a high cost, and the loss of nutrients from the fresh milk during the operation is considerable.

In summary, there is an urgent need for a method for preparing a lactose-free dairy product containing galactooligosaccharides that is capable of overcoming the above shortcomings, in particular a method for preparing a lactose-free dairy product containing galactooligosaccharides that does not require the addition of additional galactooligosaccharides and is still able to produce galactooligosaccharides in situ, and achieves a high level of galactooligosaccharides, and can attain a lactose-free standard in the final dairy product through a simple process at a low cost.

### SUMMARY OF THE INVENTION

The technical problem to be solved by the present invention is to overcome the following shortcomings of existing methods of preparing lactose-free dairy products containing galactooligosaccharides:

1) The method which simply uses β-galactosidase with a high level of transgalactosylation activity to convert lactose in a dairy product starting material to galactooligosaccharides has the problem that the lactose in the starting material of the dairy product prepared is not completely decomposed.

2) The method which simply uses lactase to completely decompose lactose in a dairy product starting material, and adds galactooligosaccharides, has the problem that the addition of galactooligosaccharides is required due to inability to produce enough galactooligosaccharides in situ, which increases the production cost and introduces the risk of external contamination during production.

The present invention provides a method for preparing a lactose-free dairy product containing galactooligosaccharides, wherein:
the method comprises a step of using ordinary lactase and β-galactosidase with transgalactosylation activity,
wherein the ordinary lactase decomposes lactose in a dairy product starting material to galactose and glucose;
wherein the β-galactosidase with transgalactosylation activity decomposes lactose in the dairy product starting material to galactose and glucose, and transfers galactose obtained through decomposition onto a hydroxyl group of lactose in the dairy product starting material to achieve conversion to galactooligosaccharides, and optionally, the β-galactosidase with transgalactosylation activity transfers galactose obtained through decomposition onto a hydroxyl group of the galactooligosaccharides to achieve conversion to higher-order galactooligosaccharides; and
wherein the galactose obtained through decomposition comprises galactose selected from the group consisting of the following:
1) galactose obtained by decomposition of lactose by the ordinary lactase; and
2) galactose obtained by decomposition of lactose by the β-galactosidase with transgalactosylation activity.

The present invention further provides a lactose-free dairy product containing galactooligosaccharides prepared by the method of the present invention.

Compared with the prior art, the present invention has the following beneficial effects: the method can produce a high level of galactooligosaccharides in the dairy product without the need to add galactooligosaccharides to the dairy product starting material, and due to the combined use of β-galactosidase with transgalactosylation activity and ordinary lactase, the method also enables the dairy product to attain a lactose-free standard through a simple process at a low cost. Moreover, since the galactooligosaccharides are produced using lactose and monosaccharides originally contained in the dairy product starting material, and galactooligosaccharides cannot be absorbed by the human body, the effect of sugar reduction is also achieved.

Other objectives, features and advantages of the present invention will become obvious from the following detailed description. However, it should be understood that although the detailed description and specific examples specify preferred embodiments of the present invention, they are only given as examples because various changes and improvements within the spirit and scope of the present invention will become obvious to those skilled in the art from the detailed description.

### DETAILED DESCRIPTION OF THE INVENTION

The present invention provides a method for preparing a lactose-free dairy product containing galactooligosaccharides, wherein:
the method comprises a step of using ordinary lactase and β-galactosidase with transgalactosylation activity,
wherein the ordinary lactase decomposes lactose in a dairy product starting material to galactose and glucose;
wherein the β-galactosidase with transgalactosylation activity decomposes lactose in the dairy product starting material to galactose and glucose, and transfers galactose obtained through decomposition onto a hydroxyl group of lactose in the dairy product starting material to achieve conversion to galactooligosaccharides, and optionally, the β-galactosidase with transgalactosylation activity transfers galactose obtained through decomposition onto a hydroxyl group of the galactooligosaccharides to achieve conversion to higher-order galactooligosaccharides; and
wherein the galactose obtained through decomposition comprises galactose selected from the group consisting of the following:
1) galactose obtained by decomposition of lactose by the ordinary lactase; and
2) galactose obtained by decomposition of lactose by the β-galactosidase with transgalactosylation activity.

The method of the present invention can produce a high level of galactooligosaccharides in the dairy product without the need to add galactooligosaccharides to the dairy product starting material, and due to the combined use of β-galactosidase with transgalactosylation activity and ordinary lactase, the method also enables the dairy product to attain a lactose-free standard through a simple process at a low cost and higher productivity. Moreover, since the galactooligosaccharides are produced using lactose and monosaccharides originally contained in the dairy product starting material, and galactooligosaccharides cannot be absorbed by the human body, the effect of sugar reduction (i.e., reduction of the total amount of monosaccharides and disaccharides) is also achieved.

The term “galactooligosaccharides” or “GOS” means oligosaccharides with stoichiometric formula (Gal)ᵢGlc or (Gal)ⱼ, where i=1-8 and j=2-9. GOS generally exists as a mixture of various GOS molecules with different degrees of polymerization and different linkage structures. The mixture may comprise straight-chain GOS molecules and branched GOS molecules. Lactose is not regarded as a GOS molecule.

The method of the present invention may use various types of “β-galactosidase with transgalactosylation activity” available in the art, as long as the β-galactosidase with transgalactosylation activity decomposes lactose in the dairy product starting material to galactose and glucose, and transfers galactose obtained through decomposition onto a hydroxyl group of lactose in the dairy product starting material to achieve conversion to galactooligosaccharides. Most preferably, the β-galactosidase with transgalactosylation activity is the enzyme preparation with brand name Nurica™ from the US company International Flavors & Fragrances; Nurica™ can utilize lactose in dairy products to naturally produce dietary fiber in the form of galactooligosaccharides. The range of enzyme activity of the Nurica™ enzyme preparation is 500-800 BLU/g, preferably 540-760 BLU/g, and the content of β-galactosidase (beta galactosidase) in the Nurica™ enzyme preparation is 5-8% (w/w).

The method of the present invention may use various types of “ordinary lactase” available in the art, as long as the ordinary lactase decomposes lactose in a dairy product starting material to galactose and glucose. Examples are Maxilact LGI 5000 and GODO-YNL2 lactase from Dupont. Most preferably, the ordinary lactase is Maxilact LGI 5000 from DSM; the range of enzyme activity of the Maxilact LGI 5000 enzyme preparation is greater than or equal to 5000 NLU/g.

Preferably, the β-galactosidase with transgalactosylation activity is used in an amount of 0.5-12 g per liter of the dairy product starting material, further preferably 2.0-11.0 g/L dairy raw material, preferably 0.5 to 6.0 g/L dairy raw material, further preferably 3.0-4.0 g per liter of the dairy product starting material; and the weight ratio of the ordinary lactase to the β-galactosidase with transgalactosylation activity is 1:1 to 1:25, preferably, the weight ratio of the common lactase and the β-galactosidase with transgalactosyl activity is in the range of 1:1 to 1:10, further preferably 1:6 to 1:7, and the weight ratio of the common lactase and the β-galactosidase with transgalactosyl activity is in the range of 1:4 to 1:22.

The present invention has no specific requirements regarding the order in which the β-galactosidase with transgalactosylation activity and the ordinary lactase are added. Preferably, the method adds the β-galactosidase with transgalactosylation activity first, and then adds the ordinary lactase. More preferably, the method adds the ordinary lactase after inactivating or partially inactivating the β-galactosidase with transgalactosylation activity. More preferably, the method may simultaneously add the β-galactosidase with transgalactosyl activity and the common lactase. Adding two enzymes at the same time can further shorten the total time of enzymatic hydrolysis in the whole production process. In addition, separate steps of enzyme inactivation can also be omitted. Other conditions after enzymatic hydrolysis (such as sterilization) can realize the role of enzyme inactivation.

The method of the present invention does not impose specific restrictions regarding the dairy product starting material that can be used, which may be selected from the group consisting of the following: fresh milk, reconstituted milk, modified milk and concentrated milk. Animal sources of the dairy product starting material include but are not limited to humans, dairy cows, sheep, goats, buffalo, camels, llamas, mares and deer, amongst which cows and sheep are preferred. Specifically, the dairy product starting material that can be used in the method of the present invention may preferably be one or more of the following:
1. fresh whole or skimmed milk;
2. reconstituted milk from whole milk powder, skimmed milk powder or concentrated milk protein;
3. fresh milk that has undergone skimming and concentration by any membrane filtration technology and backfilled with thin cream to form the required fat, protein and lactose contents;
4. fresh milk concentrated by freeze concentration technology; and
5. fresh milk concentrated by membrane evaporation technology.

Preferably, the dairy product starting material that can be used is the dairy product starting material in items 3-5 above, and the contents of components such as fat, protein and lactose in the dairy product starting material may be varied according to the demands of different groups of people. For example, concentration can significantly increase the protein content, increasing the intake efficiency.

In general, fresh whole or skimmed cow's milk has a lactose content of 4.0-5.4%, preferably 4.5-5.4%. Preferably, the dairy product starting material may have a lactose content not less than 5.0%. The dairy product starting material may also have a lactose content as high as 15.0%. Preferably, the dairy product starting material has a lactose content of 6.0%-10.0%; preferably, the dairy raw material has a lactose content of 7.0%-8.0%; more the dairy raw material has a lactose content of 8.0%-9.0%; and more the dairy raw material has a lactose content of 9.0%-10.0%. This preferred range of lactose can serve as a starting material for in situ production of enough of the required amount of GOS.

In general, fresh whole or skimmed cow's milk has a total protein content of 3.2-3.8%. Preferably, the concentrated milk has a total protein content not less than 4.0%. Preferably, the concentrated milk has a protein content of 4.0%-10.0%. Preferably, the concentrated milk has a protein content of 5.0%-9.0%. More preferably, the concentrated milk has a protein content of 5.0%-6.0%; concentrated milk in this protein content range easily meets the body's demand for protein and is easily absorbed in the gut, and there is no need to ingest an excessive amount of liquid, so an increased burden on the gut is avoided.

The concentrated milk may be obtained by various concentration methods commonly used in the art, for example, prepared by one of, or a combination of more than one of, reverse osmosis concentration, ultrafiltration, nanofiltration and membrane filtration. The reverse osmosis concentration preferably takes place at 25° C., more preferably at 2-10° C. The membrane filtration may be ultrafiltration, nanofiltration, or reverse osmosis. Concentrated fresh milk preferably has a total protein content not less than 4.0%; further optionally has a protein content of 4.0%-10.0%; and more preferably has a protein content of 5.0%-9.0%, further preferably, it has a protein content of 5.0% to 6.0%.

Furthermore, the applicant of the present application has found that when a concentrated high-protein dairy product starting material with a total protein content not less than 4.0% is used, the lactose in the high-protein dairy product starting material cannot be completely hydrolysed by using the β-galactosidase with transgalactosylation activity on its own. Moreover, if the β-galactosidase with transgalactosylation activity is not inactivated after the enzymolysis step, then during storage the presence of this enzyme will instead decompose the GOS that has already formed, for example, causing a reduction in GOS in the final product. In particular, when a fermentation step is further performed after the enzymolysis step to prepare a dairy product such as yogurt, more of the GOS produced in the enzymolysis step will be consumed if lactic acid bacteria and β-galactosidase with transgalactosylation activity that has not been inactivated are both present in the fermentation step, resulting in a significant reduction in GOS in the final product.

Thus, the β-galactosidase with transgalactosylation activity is preferably inactivated promptly after the β-galactosidase with transgalactosylation activity has completed the production of GOS, so as to reduce or avoid a significant reduction in GOS during subsequent storage or further processing (e.g., fermentation or another step). The inactivation of the β-galactosidase with transgalactosylation activity may be performed using an inactivation method commonly used in the art, such as heating inactivation (e.g., holding at 90-95° C. for 5-10 minutes) or acid inactivation (e.g., lowering the system pH value to below 4.5 by fermentation). The method of the present invention is not only able to produce GOS to a high level in situ and ensure the stability of the GOS, but also achieves a lactose-free standard through a simple process at a low cost, with high production efficiency, as well as achieving the effect of sugar reduction.

The present invention also provides a lactose-free dairy product containing galactooligosaccharides that is prepared by the method of the present invention, wherein preferably, the content of the galactooligosaccharides is 0.5-3.8 g per 100 ml of the dairy product preferably 0.5-2.3 g/100 ml, and preferably >1.0 g/100 ml, the lactose content is less than 0.2 g per 100 ml of the dairy product, more preferably less than 0.1 g per 100 ml of the dairy product, and most preferably the lactose content is 0%. The dairy product may be unflavored milk, flavored milk, ice cream, yogurt, and any liquid nutritional product that can be prepared from milk or milk components.

The objective, structural features and advantages of the present invention are explained in further detail below by listing specific examples. The examples below are listed solely for the purpose of better explaining the present invention, and do not limit the scope of protection.

### Example 1

This example is used to illustrate the method for preparing a lactose-free dairy product containing galactooligosaccharides, and the dairy product thereof.

### (1) Preparation of High-Protein, High-Lactose Milk Base

188 kg of fresh skimmed cow's milk (total protein 3.5%, lactose content 4.5%) undergoes reverse osmosis concentration at 4±2° C., and cream with a fat content of 45.0% is added to adjust the fat in the reconstituted fresh milk, to finally obtain a high-protein, high-lactose milk base with a total protein content reaching 5.3%, a fat content reaching 4.0% and a lactose content reaching 7.5%.

### (2) Enzymolysis of High-Protein, High-Lactose Milk Base

Nurica™ enzyme preparation (enzyme activity 650±150 BLU/g) is added to the high-protein milk base (5.3% protein+4.0% fat+7.5% lactose) obtained in step (1) at a concentration of 3.2 g per kg of high-protein milk base; after 15 hours of enzymolysis at 10° C., Maxilact LGI 5000 (enzyme activity greater than 5000 NLU/g) is added at a concentration of 0.5 g per kg of high-protein milk base, and enzymolysis is continued for 15 hours at a temperature of 10° C.

### (3) Post-Enzymolysis Fermentation

The post-enzymolysis high-protein, high-lactose milk base obtained in step (2) is heated to 30° C., a Kefir fermentation preparation (Choozit Kefir Mild 01 purchased from Dupont) is added at a concentration of 0.0050 g/L, then 30° C. is maintained for 20 hours. Yogurt with a pH of 4.45 is finally obtained.

### Example 2

This example is used to illustrate the method for preparing a lactose-free dairy product containing galactooligosaccharides, and the dairy product thereof.

### (1) Preparation of High-Protein, High-Lactose Milk Base

188 kg of fresh skimmed cow's milk (total protein 3.5%, lactose content 4.5%) undergoes reverse osmosis concentration at 4±2° C., and cream with a fat content of 45.0% is added to adjust the fat in the reconstituted fresh milk, to finally obtain a high-protein, high-lactose milk base with a total protein content reaching 5.3%, a fat content reaching 4.0% and a lactose content reaching 7.5%.

### (2) Enzymolysis of High-Protein, High-Lactose Milk Base

Nurica™ enzyme preparation (enzyme activity 650±150 BLU/g) is added to the high-protein milk base (5.3% protein+4.0% fat+7.5% lactose) obtained in step (1) at a concentration of 3.2 g per kg of high-protein milk base; after 15 hours of enzymolysis at 10° C., Maxilact LGI 5000 (enzyme activity greater than 5000 NLU/g) is added at a concentration of 0.5 g per kg of high-protein milk base, and enzymolysis is continued for 15 hours at a temperature of 10° C.

### (3) Preparation of Yogurt by Post-Enzymolysis Fermentation

The post-enzymolysis high-protein, high-lactose milk base obtained in step (2) is heated to 42° C., YO-MIX 558 fermentation preparation (a composite lactic acid bacteria preparation containing Streptococcus thermophilus and Lactobacillus delbrueckii subsp. bulgaricus purchased from Dupont) is added at a concentration of 0.0274 g/L, then 42° C. is maintained for 20 hours. Yogurt with a pH of 3.95 is finally obtained.

### Example 3

This example is used to illustrate the method for preparing a lactose-free dairy product containing galactooligosaccharides, and the dairy product thereof.

### (1) Preparation of High-Protein, High-Lactose Milk Base

188 kg of fresh skimmed cow's milk (total protein 3.5%, lactose content 4.5%) undergoes reverse osmosis concentration at 5° C., and cream with a fat content of 45.0% is added to adjust the fat in the reconstituted fresh milk, to finally obtain a high-protein, high-lactose milk base with a total protein content reaching 5.3%, a fat content reaching 4.0% and a lactose content reaching 7.5%.

### (2) Enzymolysis of High-Protein, High-Lactose Milk Base

Nurica™ enzyme preparation (enzyme activity 650±150 BLU/g) is added to the high-protein milk base (5.3% protein+4.0% fat+7.5% lactose) obtained in step (1) at a concentration of 3.2 g per kg of high-protein milk base; after 15 hours of enzymolysis at 10° C., heat treatment is performed at 95° C. for 7 minutes. After the heat treatment ends, the temperature falls to 42° C., Maxilact LGI 5000 (enzyme activity greater than 5000 NLU/g) is added at a concentration of 0.5 g per kg of high-protein milk base, and enzymolysis is continued for 15 hours at a temperature of 10° C. to obtain a final dairy product.

### Examples 4-9

These examples are used to illustrate the method for preparing a lactose-free dairy product containing galactooligosaccharides, and the dairy product thereof.

### (1) Preparation of High-Protein, High-Lactose Milk Base

188 kg of fresh cow's milk (total protein 3.3%, lactose content 4.3%) undergoes reverse osmosis concentration at 5° C., and cream with a fat content of 30-45.0% is added to adjust the fat in the reconstituted fresh milk, to finally obtain a high-protein, high-lactose milk base with a total protein content reaching 6.5%, a fat content reaching 3.8% and a lactose content reaching 7.5-9.8% (see Table 1 for details).

### (2) Enzymolysis of High-Protein, High-Lactose Milk Base

Nurica™ enzyme preparation (enzyme activity 650±150 BLU/g) and Maxilact LGI 5000 (enzyme activity greater than 5000 NLU/g) are added simultaneously to the high-protein milk base (6.5% protein+3.8% fat+7.5% lactose or 6.5% protein+3.8% fat+9.8% lactose) obtained in step (1); after 18-20 hours of enzymolysis at 10° C., heat treatment is performed at 90° C. for 10 minutes to obtain a final dairy product. The concentrations of the Nurica™ enzyme preparation and Maxilact LGI 5000 are as shown in Table 1 below.

TABLE 1

| | | | Lactose content of |
|---|---|---|---|
| | Nurica ™ enzyme | Maxilact LGI | high-protein, high- |
| | preparation (g per | 5000 (g per | lactose milk base (g |
| | kg of high-protein | kg of high-protein | per 100 g of high- |
| Sample | milk base) | milk base) | protein milk base) |
| Example 4 | 1.5 | 0.8 | 7.5 |
| Example 5 | 2.0 | 1.0 | 7.5 |
| Example 6 | 4.0 | 0.8 | 9.8 |
| Example 7 | 7.0 | 0.8 | 9.8 |
| Example 8 | 11.0 | 0.5 | 9.8 |
| Example 9 | 2.0 | 0.5 | 9.8 |

### Comparison Example 1

This comparison example is used to illustrate a method in the prior art for preparing a lactose-free dairy product containing galactooligosaccharides, and the dairy product thereof.

### (1) Preparation of High-Protein, High-Lactose Milk Base

188 kg of fresh skimmed cow's milk (total protein 3.5%, lactose content 4.5%) undergoes reverse osmosis concentration at 5° C., and cream with a fat content of 45.0% is added to adjust the fat in the reconstituted fresh milk, to finally obtain a high-protein, high-lactose milk base with a total protein content reaching 5.3%, a fat content reaching 4.0% and a lactose content reaching 7.5%.

### (2) Enzymolysis of High-Protein, High-Lactose Milk Base Using Only Maxilact LGI 5000

Maxilact LGI 5000 (enzyme activity greater than 5000 NLU/g) is added to the high-protein milk base (5.3% protein+4.0% fat+7.5% lactose) obtained in step (1) at a concentration of 0.5 g per kg of high-protein milk base, and after 15 hours of enzymolysis at a temperature of 10° C., a final dairy product is obtained.

### Comparison Example 2

This comparison example is used to illustrate a method in the prior art for preparing a lactose-free dairy product containing galactooligosaccharides, and the dairy product thereof.

### (1) Preparation of High-Protein, High-Lactose Milk Base

188 kg of fresh skimmed cow's milk (total protein 3.5%, lactose content 4.5%) undergoes reverse osmosis concentration at 5° C., and cream with a fat content of 45.0% is added to adjust the fat in the reconstituted fresh milk, to finally obtain a high-protein, high-lactose milk base with a total protein content reaching 5.3%, a fat content reaching 4.0% and a lactose content reaching 7.5%.

### (2) Enzymolysis of High-Protein, High-Lactose Milk Base Using Only Nurica™ Enzyme Preparation

Nurica™ enzyme preparation (enzyme activity 650±150 BLU/g) is added to the high-protein milk base (5.3% protein+4.0% fat+7.5% lactose) obtained in step (1) at a concentration of 3.2 g per kg of high-protein milk base, and after 15 hours of enzymolysis at 10° C., a final dairy product is obtained.

### Comparison Example 3

This comparison example is used to illustrate a method in the prior art for preparing a lactose-free dairy product containing galactooligosaccharides, and the dairy product thereof.

### (1) Preparation of High-Protein, High-Lactose Milk Base

188 kg of fresh cow's milk (total protein 3.3%, lactose content 4.3%) undergoes reverse osmosis concentration at 5° C., and cream with a fat content of 30-45.0% is added to adjust the fat in the reconstituted fresh milk, to finally obtain a high-protein, high-lactose milk base with a total protein content reaching 6.5%, a fat content reaching 3.8% and a lactose content reaching 9.8%.

### (2) Enzymolysis of High-Protein, High-Lactose Milk Base Using Only Nurica™ Enzyme Preparation

Nurica™ enzyme preparation (enzyme activity 650±150 BLU/g) is added to the high-protein milk base (6.5% protein+3.8% fat+9.8% lactose) obtained in step (1) at a concentration of 2.0 g per kg of high-protein milk base, and after 20 hours of enzymolysis at 10° C., heat treatment is performed at 90° C. for 10 minutes to obtain a final dairy product.

The dairy products obtained in Examples 1-9 and Comparison examples 1-3 above are all sterilized by ultra-high temperature (UHT) instantaneous sterilization, the sterilization temperature being 137 degrees Celsius and the sterilization time being 4 seconds.

### Effect Verification Example

The dairy products obtained in Examples 1-3 and Comparison examples 1-2 were tested for sugar composition under the same conditions.

The method for testing the sugar composition was as follows:

Carrez reagents 1 & 2 were added to 1 ml of the sample to be tested in an amount sufficient to cause all solids to coagulate. The two-phase mixture was centrifuged for 15 minutes (6000 rpm), and a disposable PTFE microfilter (0.22 microns) was used for further filtration. The final clear solution of saccharides was then placed in an HPLC vial and analysed.

The HPLC method used was as follows:
System: Waters
Column: Agilent HiPlex Ca polymeric ion exchange column
Eluent: MilliQ water
Column temperature: 60° C.
Flow speed: 0.6 mL/min
Pressure: 600 psi (for such a column, the maximum is 1000 psi)
Detector: RID, at 35° C.

Quantification is based on peak area and known lactose concentration. The response factor of all sugars was also calculated. Analytical standards of DP2, DP3 and DP4 oligosaccharides and monosaccharides from Sigma were already used previously to determine the oligosaccharide retention time.

The sugar composition was tested when the dairy product had just been prepared, after 3 days of storage at 10° C., and after 17 days of storage at 10° C. The test results are shown in Table 2 below:

TABLE 2

| | | Lactose/galactose/ | Lactose/galactose/ |
|---|---|---|---|
| | Lactose/galactose/ | GOS (measured | GOS (measured |
| | GOS (measured | after 3 days | after 17 days |
| Sample | immediately) | of storage) | of storage) |
| Example 1 | 0/3.6/2.4 | 0/3.8/1.6 | Not measured *** |
| Example 2 | 0/2.8/2.0 | 0/2.9/1.8 | Not measured ** |
| Example 3 | 0/2.7/1.7 | 0/2.6/1.3 | 0/1.7/1.0 |
| Comparison | 0/4.0/0 | 0/3.7/0 | 0/3.5/0 |
| example 1 | | | |
| Comparison | 3.1/0.8/2.1 | 3.2/1.1/2.3 | 2.3/2.0/2.0 |
| example 2 | | | |

In the sugar composition test above, the test results are in units of g/100 g
*** The storage temperature in this test was 10° C.; at this temperature, the shelf life of yogurt products will generally not exceed 7 days, so the sugar composition of Examples 1-2 after 17 days of storage was not measured.

It can be seen from Table 2 that after concentration of the dairy product starting material used in Examples 1-3, the concentrations of protein and lactose are both increased, and because β-galactosidase with a high level of transgalactosylation activity and ordinary lactase are used in combination, the high content of lactose in the concentrated milk is completely decomposed and converted to GOS, thereby obtaining a high-protein, high-GOS and low-monosaccharide dairy product. In comparison examples 1-2, β-galactosidase with a high level of transgalactosylation activity is used on its own, or ordinary lactase is used on its own; either the lactose cannot be completely decomposed, or no GOS is produced, so the excellent properties of the dairy product prepared by the method of the present invention cannot be achieved in either case.

Furthermore, since the yogurt preparation process also comprises a fermentation step, those skilled in the art would generally think that fermentation would cause decomposition of GOS; however, it can be seen from the results shown in Table 3 below that the content of naturally produced GOS is not significantly reduced by the yogurt fermentation step of the different processes in Examples 1-2 of the present invention, and is still sufficient to produce a prebiotic effect.

TABLE 3

| | GOS measured | GOS measured |
|---|---|---|
| | immediately | immediately |
| | after step (2) | after step (3) |
| Sample | (g/100 g) | (g/100 g) |
| Example 1 | 2.7 | 2.4 |
| Example 2 | 2.7 | 2.4 |

That is to say, in the methods of Examples 1-2 of the present invention, a fermentation step is also performed after the enzymolysis step to prepare yogurt; the fermentation step does not significantly affect the GOS content, and furthermore, compared with the technical solution of Example 3 in which the β-galactosidase with a high level of transgalactosylation activity is inactivated by heating, the technical solution that includes the fermentation step can also omit the special step of inactivating the enzyme, thereby achieving the technical effects of increasing production efficiency and reducing production costs.

Samples of Examples 4-9 and Comparison example 3 underwent sugar composition testing when the dairy product had just been prepared:

TABLE 4

| | Lactose | GOS |
|---|---|---|
| Sample | content (%) | content (%) |
| Example 4 | 0.0 | 1.7 |
| Example 5 | 0.0 | 1.5 |
| Example 6 | 0.2 | 2.4 |
| Example 7 | 0.0 | 2.8 |
| Example 8 | 0.0 | 3.5 |
| Example 9 | 0.2 | 1.9 |
| Comparative | 4.9 | 1.8 |
| example 3 | | |

It can be seen from Table 4 that adding the two types of enzyme simultaneously can significantly reduce the time needed for enzymolysis, and the final dairy product can meet the content requirements of national standard GB28050-2011 for being lactose-free.

The present invention schematically disclosed herein may be suitably implemented in the absence of any element not specifically disclosed herein. However, it will be obvious to those skilled in the art that many changes, alterations and improvements to the method as well as other uses and applications thereof are possible; changes, alterations, improvements, other uses and applications which do not deviate from the spirit and scope of the present invention are also considered to be covered by the present invention, which is defined by the attached claims alone.

1. A method for preparing a lactose-free dairy product containing galactooligosaccharides, characterized in that
the method comprises a step of using ordinary lactase and β-galactosidase with transgalactosylation activity,
wherein the ordinary lactase decomposes lactose in a dairy product starting material to galactose and glucose;
wherein the β-galactosidase with transgalactosylation activity decomposes lactose in the dairy product starting material to galactose and glucose, and transfers galactose obtained through decomposition onto a hydroxyl group of lactose in the dairy product starting material to achieve conversion to galactooligosaccharides, and optionally, the β-galactosidase with transgalactosylation activity transfers galactose obtained through decomposition onto a hydroxyl group of the galactooligosaccharides to achieve conversion to higher-order galactooligosaccharides; and
wherein the galactose obtained through decomposition comprises galactose selected from the group consisting of the following:
1) galactose obtained by decomposition of lactose by the ordinary lactase; and
2) galactose obtained by decomposition of lactose by the β-galactosidase with transgalactosylation activity.

2. The method as claimed in claim 1, characterized in that the β-galactosidase with transgalactosylation activity is used in an amount of 0.5-12.0 g per liter of dairy product starting material; and the weight ratio of the ordinary lactase to the β-galactosidase with transgalactosylation activity is 1:1 to 1:25.

3. The method of claim 2, wherein the dosage of the β-galactosidase having transgalactosylating activity ranges from 0.5 g/L to 6.0 g/L of the dairy raw material, and the weight ratio of the ordinary lactase and β-galactosidase having transgalactosylating activity ranges from 1:1 to 1:10.

4. The method of claim 2, wherein the dosage of the β-galactosidase having transgalactosylating activity ranges from 2.0 g/L to 11.0 g/L of the dairy raw material, and the weight ratio of the ordinary lactase and β-galactosidase having transgalactosylating activity ranges from 1:4 to 1:22.

5. The method of claim 1, characterized in that the method adds the β-galactosidase with transgalactosylation activity first, and then adds the ordinary lactase.

6. The method as claimed in claim 5, characterized in that the method adds the ordinary lactase after inactivating or partially inactivating the β-galactosidase with transgalactosylation activity.

7. The method of claim 1, characterized in that the method adds the β-galactosidase with transgalactosylation activity and the ordinary lactase simultaneously.

8. The method of claim 1, characterized in that the dairy product starting material is selected from the group consisting of the following: fresh milk, reconstituted milk, modified milk and concentrated milk.

9. The method as claimed in claim 8, characterized in that the dairy product starting material has a lactose content not less than 5.0%.

10. The method of claim 8, characterized in that the concentrated milk has a total protein content not less than 4.0%.

11. The method as claimed in claim 10, characterized in that the concentrated milk is prepared by one of, or a combination of more than one of, reverse osmosis concentration, ultrafiltration, nanofiltration and membrane filtration.

12. The method of claim 1, characterized in that the β-galactosidase with transgalactosylation activity is Nurica™.

13. The method of claim 1, characterized in that the ordinary lactase is Maxilact LGI 5000.

14. A lactose-free dairy product containing galactooligosaccharides, prepared by the method as claimed in claim 1.
